(19) United States
(12) Patent Application Publication
(10) Pub. No.: US 2007/0052554 A1
(43) Pub. Date: Mar. 8, 2007

(54) Methods and systems for logistics health status display

(75) Inventors: Jeremy R. Wallace, O'Fallon, MO (US); Laura Schmidt, Chesterfield, MO (US); David A. Followell, Wildwood, MO (US)

Correspondence Address: LEE & HAYES, PLLC, 421 W. RIVERSIDE AVE., SUITE 500, SPOKANE, WA, 99201, US

(73) Assignee: The Boeing Company, Chicago, IL (US)

(21) Appl. No.: 11/210,367

(22) Filed: Aug. 24, 2005

(51) Int. Cl. G01C 23/00

(52) U.S. Cl. 340/971

(57) ABSTRACT

This application is directed towards methods and systems for displaying health status messages and similar information from equipment, including inputting a plurality of status messages and displaying color status indicators reflecting status information. In another embodiment, the color status indicators includes one of a red, green, and yellow indicator. Further, a computer program product includes computer readable media for inputting a plurality of status messages and displaying a plurality of indicators to display equipment status. In another embodiment, the plurality of indicators include fuel levels, operational capabilities, and maintenance health status. In a further embodiment, a system for displaying the health status of aircraft includes a processor arranged to receive a plurality of health status indicators, a display arranged to display the indicators, a graphical interface for a user with a pointing device, and a database arranged to display background information of the aircraft upon selection by the user.

### CROSS-REFERENCE TO RELATED APPLICATIONS

This patent application is related to co-pending, commonly-owned U.S. Patent Application No. (undetermined), entitled METHODS AND SYSTEMS FOR LOGISTICS HEALTH STATUS REASONER, filed under attorney docket no. BING-1-1171 concurrently herewith on Aug. 24, 2005, which application is hereby incorporated by reference.

### FIELD OF THE INVENTION

This invention relates generally to equipment logistics systems and, more specifically, to the display of logistics information.

### BACKGROUND OF THE INVENTION

Data concerning equipment or operating platforms, such as in a military environment, often generate health status messages, or have health status messages prepared by users or maintenance staff. Typically, such health status messages may address various aspects of the equipment's systems, subsystems, capabilities and status. Such messages are often specific to the equipment and operating platform, and thus may not be readily available for review and display by a supervising logistics team, especially on a real time basis. Accordingly, there is an unmet need for displaying logistics status information in a readily monitored format.

### SUMMARY

Embodiments of the present invention are directed toward systems and methods for displaying health status messages and similar information from equipment. In one embodiment, a method of displaying health status information includes inputting a plurality of status messages concerning pieces of equipment, wherein a portion of the status messages include a result of comparing the status of a piece of equipment with a user-determined threshold, and displaying color status indicators reflecting status information concerning the piece of equipment. Further embodiments include outputting detailed or background information from the health status message in a format accessible to a user through a graphical user interface. The color status indicators may include one of a red, green, and yellow indicator concerning a health status aspect of the equipment.

In yet another embodiment, a computer program product includes computer readable media for inputting a plurality of equipment status messages and displaying a plurality of indicators to display equipment status and a plurality of results of comparing the equipment status information with assigned operational tasks for the pieces of equipment. The plurality of indicators may include fuel levels of the equipment, operational capabilities of the equipment, and maintenance health status of the equipment.

In a further embodiment, a system for displaying the health status of a plurality of aircraft includes a processor arranged to receive a plurality of health status indicators relating to the aircraft, a display arranged to display a plurality of health status indicators, a graphical interface to accept selection of a health status indicator by a user with a pointing device, and a database arranged to display further health status background information of the aircraft upon selection by the user of a health status indicator.

### BRIEF DESCRIPTION OF THE DRAWINGS

Embodiments of the present invention are described in detail below with reference to the following drawings.

FIG. 1 is a component diagram of an exemplary logistics health status system in accordance with an embodiment of the present invention;

FIG. 2 is a component drawing of an alternate logistics health status system in accordance with another embodiment of the present invention;

FIG. 3 is a screen shot of an exemplary logistics health status display in accordance with an embodiment of the present invention;

FIG. 4 is a screen shot in accordance with a health status display of the present invention showing additional background status information;

FIG. 5 is flowchart of an exemplary equipment health status process in accordance with an embodiment of the present invention;

FIG. 6 is a flowchart of an exemplary health status reasoner process in accordance with an embodiment of the present invention; and

FIG. 7 is a flowchart of an exemplary health status display process in accordance with another embodiment of the present invention.

### DETAILED DESCRIPTION

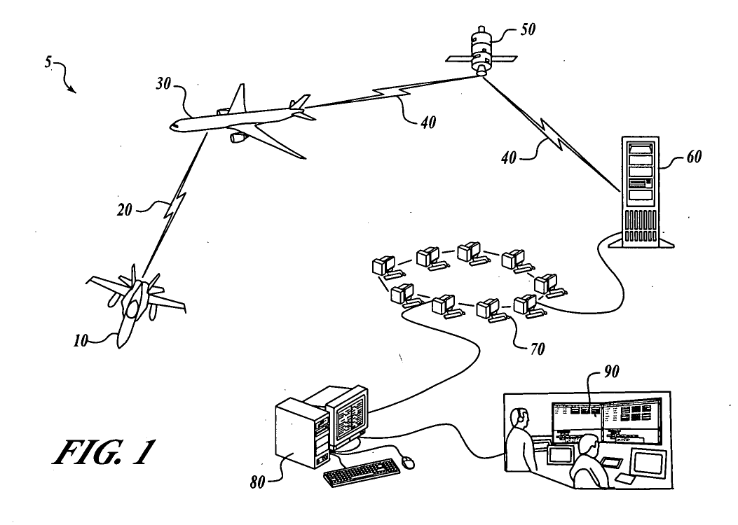

The present invention relates to systems and methods for displaying equipment health status. Many specific details of certain embodiments of the invention are set forth in the following description of FIGS. 1-7 to provide a thorough understanding of such embodiments. One skilled in the art, however, will understand that the present invention may have additional embodiments, or that the present invention may be practiced without one or more of the details described in the following description.

FIG. 1 shows an exemplary logistics data system 5 in accordance with an embodiment of the present invention. In this embodiment, an operational platform or piece of equipment 10, in this instance an aircraft, is linked by a wireless link 20 to a relay link 30. In the embodiment shown in FIG. 1, the relay link 30 is a relay aircraft. The relay link 30 is coupled by a first satellite link 40 to a satellite 50, and in turn, the satellite 50 is coupled through a second satellite link 40 to a guardian processor 60. The guardian processor 60 validates information from the equipment 10. The guardian processor 60 is coupled to a network 70 that further relays and permits access to the information from the equipment 10 by an array of users or processors.

As further shown in FIG. 1, a reasoner processor 80 is coupled to the network 70. The reasoner processor 80 processes health status messages from the equipment 10. The health status message information, as described further below, may include fuel levels of the equipment 10, operational capabilities of the platform 10, and/or maintenance status of the platform 10. The reasoner processor 80 compares the information from the platform 10 with predetermined thresholds (e.g. user determined thresholds) related to the desired operations of the equipment 10, and generates health status indicators that may be presented on a display 90 either linked directly to the reasonable processor 80, or otherwise coupled to the network 70. The health status information from the platform 10 is then displayed in a readily-utilized format for single or multiple users anywhere the network 70 may be accessed.

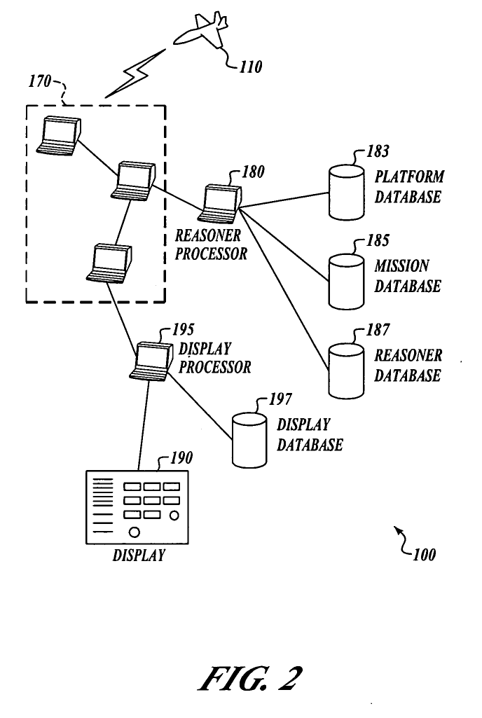

FIG. 2 shows an alternate logistics health status system 100 in accordance with another embodiment of the present invention. In this embodiment, a piece of equipment 110 is linked to a network of processors 170. Also linked to the network 170 is a reasoner processor 180. The reasoner processor 180 is linked to three databases: a platform database 183, a mission database 185, and a reasoner database 187. The platform database 183 contains background information concerning the specific equipment 110, including its capabilities, equipment subsystems, and logistics and materials needs, for comparison by the reasoner processor 180 with health status messages from the equipment 110. The mission database 185 includes information concerning the assigned or proposed mission or task for the equipment 110. By way of example and not limitation, if the equipment 110 is a military aircraft, the mission database 185 may include distance to the proposed target, and weapons intended to be deployed at the target. The reasoner database 187 contains instructions for processing incoming health messages from the equipment 110 and comparing them to threshold information in the platform database 183, and in the mission database 185. The reasoner processor 180 then generates one or more equipment health status indicators (not shown) for distribution through the network 170 (or other use).

In this embodiment, the health status indicators are posted to the network 170 for pick-up by one or more display processors 195, also linked to the network 170. The display processor 195 is linked to a display database 197, which maintains current health status indicators for a plurality of pieces of equipment, such as equipment 110. The health status indicators are then displayed on a display 190. The display 190 may display health status indicators for a plurality of platforms or pieces of equipment such as equipment 110. It will be appreciated that the various databases of the system 100 may be located separate from the processors 180, 195, and may be combined and segregated into a variety of locations, physical equipment, memory, and/or configurations.

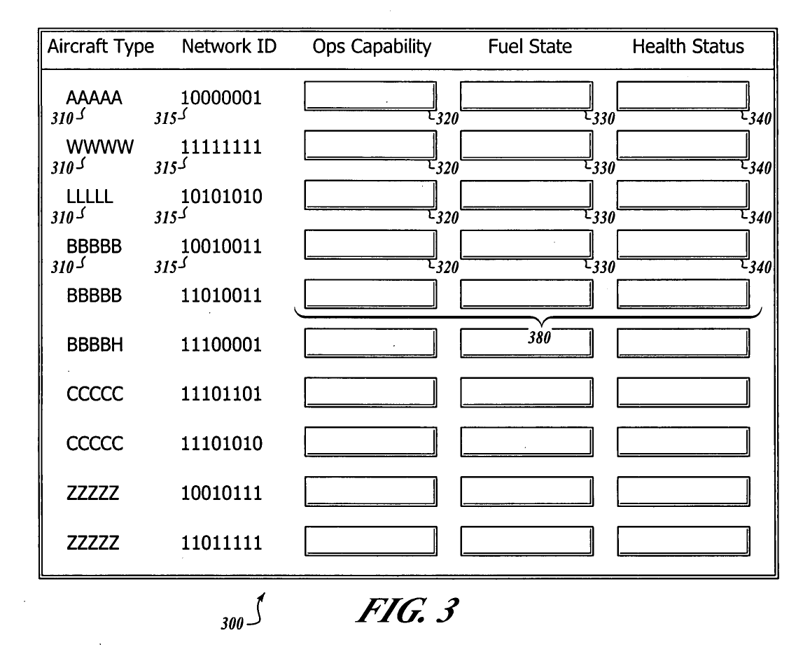

FIG. 3 is a screen shot of a health status display 300 in accordance with an embodiment of the present invention. The display 300 includes a plurality of health status indicators 380 for each piece of equipment monitored on the display 300. The health status indicators 380 may appear in various colors, and may change colors depending up the health status of the particular systems being monitored. In the embodiment shown in FIG. 3, the equipment (not shown) are aircraft and an aircraft type 310 is listed for each aircraft. A network ID number (or identifier) 315 is listed for each aircraft. For each aircraft, an operations capability indicator 320, a fuel state indicator 330, and a health status indicator 340 are displayed. By way of example and not limitation, in this embodiment, the operations, fuel, and health status indicators 320, 330, and 340, respectively, may be variously red, yellow, and green, depending upon the status of the aircraft. In the manner of a conventional traffic stoplight, in one specific embodiment, a green indicator may indicate the aircraft (or indicated factor or system) is ready and/or meets requirements, a yellow indicator may indicate caution or marginal capability or status, and a red may indicate not currently functional status in the reference category. In this embodiment, the operations capability 320 means the status of the aircraft 310 to perform its currently tasked or planned operations. The fuel state indicator 330 indicates the fuel status of the aircraft 310 (e.g. ability to reach and return from its currently tasked target). The health status indicator 340 includes maintenance status of the aircraft 310 and its systems. Put differently, in some embodiments, the operations capability indicator 320 may be determined by information from the equipment, crew, or reviewing staff as to whether the system is mission capable or non-mission capable for the specific mission the equipment 310 is performing. Similarly, the fuel state indicator 330 may be determined by the mission requirements, and the health status indicator 340 may display results of monitoring systems or subsystems of the equipment, such as radar warning systems, transponder systems, and weapons systems.

If there is a change in the status of the operations capability, fuel state, or health status of, by way of example, an aircraft 310 on the display 300, the appropriate indicator 380 of the status display 300 will change to the appropriate color. The displayed data may be used, for example, by decision planners and maintenance staff to make tasking or logistics support, such as maintenance or fueling, decisions for the equipment 310 and systems monitored by the display 300.

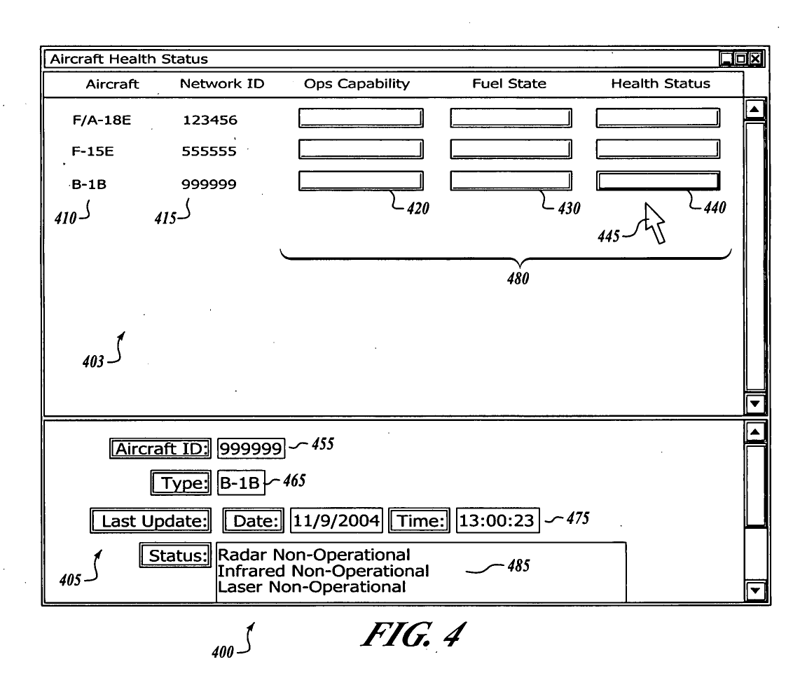

FIG. 4 is a screen shot of an alternate aircraft health status display 400 in accordance with another embodiment of the present invention. The health status display 400 includes a general health status display 403 for, in this display, three aircraft 410 each with a network identifier 415. Operations capability 420, fuel state 430, and health status 440 indicators for each of the aircraft 410 are displayed. In one specific embodiment, the indicators are variously red, yellow, or green colors for each status indicator 420, 430, 440 for each aircraft 410, displayed in tabular format, the indicators for each aircraft displayed along a horizontally line level with the respective aircraft name and identifier. In this example display 400, a pointing device 445 may be movable throughout the display 400, and may be pointed to a health status indicator 440 for one of the aircraft 410 to access additional background information, such as an indicator which is showing a red or “no go” status. More specifically, in one embodiment, using the pointer 445, a user brings up a sub-display 405 on the display 400 with additional information regarding the health status of the selected equipment 410, in this instance an aircraft. By way of example, in the sub-display 405, the aircraft identifier 455 is displayed, as is the aircraft type 465. A last update date and time 475 is posted with indicators indicating the date and time of the last health status information received from the aircraft. Detailed status information 485 for the aircraft 410 is also shown. In this embodiment, the detailed status information 485 shows that the aircraft's radar, infrared, and laser systems are non-operational.

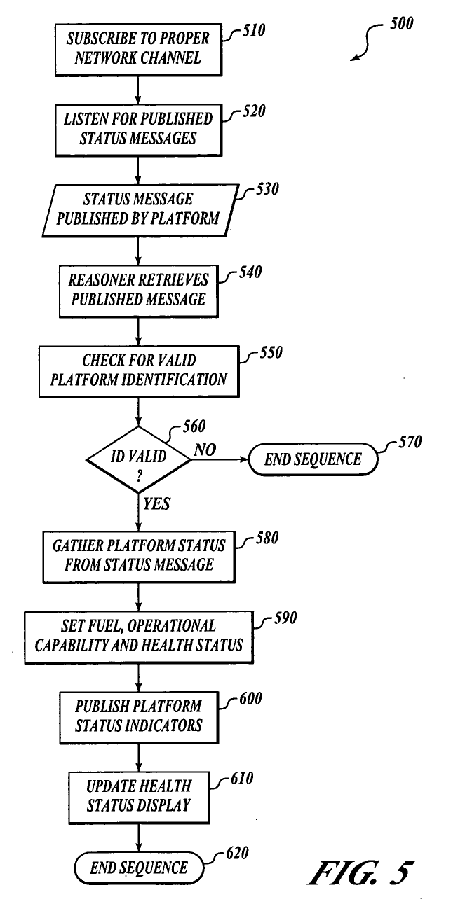

FIG. 5 is a flowchart of the process 500 of a health status system in accordance with an embodiment of the present invention. At a block 510, a health status reasoner and a health status display are subscribed to a network channel. At a block 520, the health status reasoner listens for published health status messages. At a block 530, a health status message is published to the network. This may occur autonomously by a platform or piece of equipment, or by the input of a user, such as a maintenance technician or other supervising personnel. At a block 540, the health status reasoner retrieves the published status message. At a block 550, the health status reasoner checks for valid platform identification to confirm secure identification for the platform. At a decision block 560, an inquiry is made as to whether the identification is valid. If the posted identification is not valid, the sequence ends at a block 570. If the identification for the health status message is valid, at a block 580, the reasoner gathers the platform status from the status message. At a block 590, the reasoner converts the health status message into one or more indicators, including, for example, fuel, operational capability, and health status indicators, as described with reference to FIG. 2 above. The reasoner may convert the health status message into one or more indicators by consulting a platform database with information concerning the equipment, and a mission database information concerning the mission tasked to the equipment. The health status reasoner publishes the derived platform status indicators to the network at a block 600. At a block 610, the health status display picks up the platform status indicators and updates the health status display to include the health status indicators just received from the network. At a block 620, the sequence ends, until further updates are received, processed, and updated on the health status display.

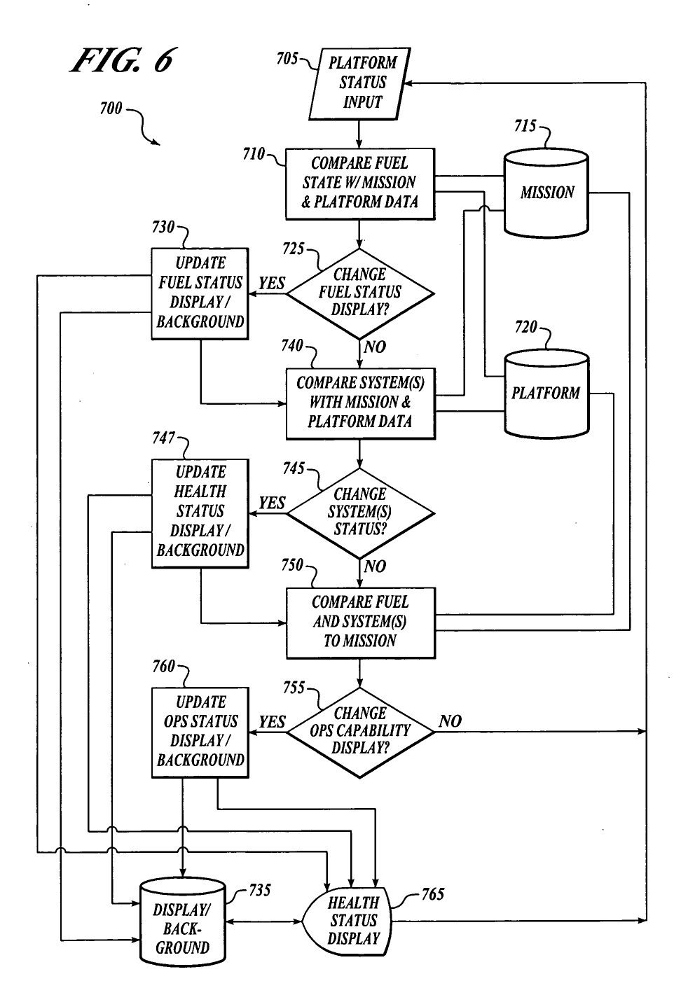

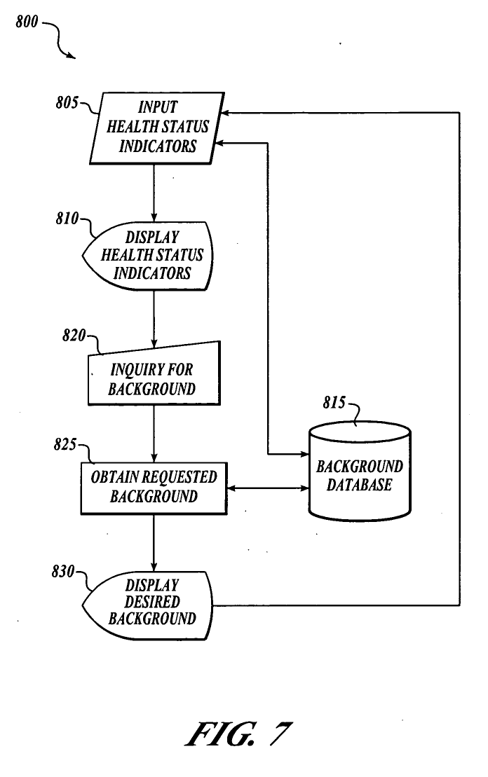

FIG. 6 is a detailed flowchart of an exemplary health status reasoner process 700 in accordance with another embodiment of the present invention. At a block 705, platform status messages are input by the reasoner. At a block 710, fuel state information from the platform status message is compared with mission and platform data. Mission data is derived from a mission database 715, and platform data is derived from a platform database 720. As a result of comparing the fuel state with the mission and platform data, a decision is made at a decision block 725 as to whether to change the fuel status display for the platform or piece of equipment under review. If there is a change in fuel status, the fuel status indicator is updated at a block 730, with additional background data concerning the fuel status information from the platform status message made available for access by a user utilizing the health status display, such as described further with reference to FIG. 7 below.

If the fuel status information does not need to be changed, or after update of the fuel status indicator at a block 730, the health status reasoner at a block 740 compares the platform systems with mission and platform data, again consulting the mission database 715 and the platform database 720. At a decision block 745, the reasoner determines whether it is necessary to change displayed system health status indicator. If the system status for the platform needs to be changed, at a block 747 the health status indicator is updated and background information relating to the system health for the platform are made available to users.

As further shown in FIG. 6, the reasoner then compares the fuel status and the system status to mission requirements at a block 750, again consulting the mission database 715 and the platform database 720, evaluating whether the platform or piece of equipment is capable for the operation tasked to the equipment. At a decision block 755, the reasoner determines whether the operations capability of the platform is to be changed. If the operations capability of the platform is to be changed, at a block 760, the system updates the operations status indicators, and posts operations background information from the platform status messages to users utilizing a health status display. When fuel status background information (block 730), health status background information (block 747), and operations status background information (block 760), are made available to users of a health status display, by way of example, but not limitation, that information may stored to a display indicator and background information database 735. The display/background information database 735 may be accessed by a health status display at a block 765, such as described further with reference to FIG. 7 below.

If at the block 755, the operations capability display does not need to be changed, the system reasoner returns to awaiting platform status messages inputs at the block 705. When the reasoner updates the fuel status display indicators at a block 730, the health status indicators at a block 755, and the operations status indicators at a block 760, those indicators are transmitted to a health status display 765, as well as being stored in the display indicator and background information database 735.

FIG. 7 is a flowchart of an exemplary health status display process 800 in accordance with still another embodiment of the present invention. At a block 805, health status indicators are input, such as from a network. As noted above, the health status indicators are compiled indicators reflecting compiled health status values for equipment, such as those generated by the health status reasoner. At block 805, the health status indicators and any desired linked background information may be saved in a background database 815 for local access by the health status display. Alternately, the health status indicators and related background information for the equipment being monitored may be stored elsewhere on a network, or at a database situated near a health status reasoner receiving health status messages from the equipment.

At a block 810, the health status indicators are displayed. If there is an inquiry for background information at a block 820, such as triggered by a user pointing device as described above with reference to FIG. 4, the health status display at a block 825 obtains the background information in the category requested. In this example, the display pulls the requested background or detailed health status information from the background database 815. The desired background information is then displayed at a block 830. The process then returns to block 805 to await revised health status indicators as they are received, such as when they are published to a network linked to the health status display.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for displaying status messages from a plurality of pieces of equipment comprising:
inputting a plurality of status messages including status information concerning the pieces of equipment; wherein a portion of the status messages include a result of comparing the status of a piece of equipment with a user-determined threshold; and
displaying a plurality of color status indicators reflecting the status information from the status messages concerning the pieces of equipment.

2. The method of claim 1 wherein inputting includes inputting from a secure network of processors.

3. The method of claim 1 wherein at least one status message includes fuel level information.

4. The method of claim 1 wherein at least one status message includes information concerning the piece of equipment's ability to perform a user-determined operation.

5. The method of claim 1 wherein at least one status message includes equipment health information.

6. The method of claim 5 wherein the equipment health information includes maintenance status information.

7. The method of claim 1 wherein displaying a color status indicator includes outputting additional information from the status message in a user-determined format accessible to a user through a graphical user interface.

8. The method of claim 1 wherein the plurality of indicators include fuel level information, operational capability information, and equipment health information.

9. The method of claim 1 wherein the pieces of equipment includes a plurality of aircraft.

10. The method of claim 1 wherein the color status indicators includes one of red, green and yellow.

11. The method of claim 1 further comprising displaying at least one of an equipment type and an equipment identification code.

12. The method of claim 1 further comprising utilizing a pointing device to select a color display indicator on a graphical user interface, and displaying additional information from the status message.

13. A computer program product for displaying equipment status information comprising:
computer readable media for inputting a plurality of equipment status messages including equipment status information concerning a plurality of pieces of equipment;
computer readable media for inputting a plurality of results of comparing the equipment status information with assigned operational tasks for the pieces of equipment;
computer readable media for displaying a plurality of first indicators to display the equipment status information;
computer readable media for displaying a plurality of second indicators to display the results of comparing the equipment status information with assigned operational tasks for the pieces of equipment; and
computer readable media for outputting the first indicators and the second indicators for display.

14. The product of claim 14, wherein the plurality of first indicators include fuel levels of the equipment, and maintenance health status of the equipment.

15. The product of claim 14, wherein the operational tasks for the pieces of the equipment include a plurality of military missions.

16. A system for displaying the health status of a plurality of aircraft comprising:
a processor arranged to receive a plurality of health status indicators, wherein a portion of the health status indicators include a result of comparing the status of an aircraft with a user-determined threshold;
a display arranged to display the plurality of health status indicators relating to the aircraft, and arranged to accept selection by a user with a pointing device of a health status indicator; and
a database arranged to display health status background information relating to an aircraft upon selection by the user of a health status indicator.

17. The product of claim 17, wherein the health status indicator includes one of fuel level of the aircraft, operational capability of the aircraft, and maintenance health of the aircraft.

18. The product of claim 17, wherein the user-determined threshold includes requirements to complete an assigned military mission.
